(19) United States
(12) Patent Application Publication
(10) Pub. No.: US 2021/0300309 A1
(43) Pub. Date: Sep. 30, 2021

(54) CONTROL METHOD FOR ANTI-LOCK BRAKE DEVICE AND ANTI-LOCK BRAKE ASSEMBLY FOR BICYCLE

(71) Applicant: TEKTRO TECHNOLOGY CORPORATION, Changhua County (TW)

(72) Inventors: Po-Hsien HUANG, Changhua County (TW); Tzu-Chang WANG, Changhua County (TW)

(21) Appl. No.: 17/158,307

(22) Filed: Jan. 26, 2021

(30) Foreign Application Priority Data
Mar. 27, 2020 (TW) 109110543

(51) Int. Cl. B60T 8/1761; B62L 3/02; B60T 8/17; B60T 8/32

(52) U.S. Cl. CPC B60T 8/17616; B62L 3/023; B60T 2270/10; B60T 8/3225; B60T 8/1706

(57) ABSTRACT

A control method for bicycle anti-lock brake device includes determining whether a wheel deceleration of the bicycle is larger than or equal to a deceleration threshold. When the wheel deceleration of the bicycle is determined to be smaller than the deceleration threshold, the anti-lock brake device of the bicycle is inactivated. When the wheel deceleration of the bicycle is determined to be larger than or equal to the deceleration threshold, determining whether a wheel speed of the bicycle is larger than or equal to a wheel speed threshold. When the wheel speed of the bicycle is determined to be larger than or equal to the wheel speed threshold, the anti-lock brake device of the bicycle is activated. when the wheel speed of the bicycle is determined to be smaller than the wheel speed threshold, the anti-lock brake device of the bicycle is inactivated.

### CROSS-REFERENCE TO RELATED APPLICATIONS

This non-provisional application claims priority under 35 U.S.C. § 119(a) on patent application No(s). 109110543 filed in Taiwan, R.O.C. on Mar. 27, 2020, the entire contents of which are hereby incorporated by reference.

### TECHNICAL FIELD

The disclosure provides a control method and an anti-lock brake assembly, more particularly to a control method for an anti-lock brake device and an anti-lock brake assembly for bicycle.

### BACKGROUND

In recent years, road bikes, mountain bikes and other types of bikes become more and more popular so that the manufacturers pay more attention on developing new and market-oriented products in order to provide costumers a better riding experience and a more stylish appearance of bicycle. However, in the safety aspect, the conventional bikes in the market still need to be improved.

Brake system is one of the most important factors to the bicycle safety. The caliper is the most commonly used means in the brake system. The caliper is disposed near a brake disk which is rotatable with a bicycle wheel, and it is able to clamp the brake disk to stop the rotation of the bicycle wheel as the rider squeeze the brake lever. However, when the rider squeezes the brake lever too hard, the wheel may be locked up by the caliper and thus causing the bicycle to skid. In such a case, the rider loses control of the bicycle, easily resulting in an accident. Therefore, the above problem is required to be solved.

### SUMMARY

The disclosure provides a control method for an anti-lock brake device and an anti-lock brake assembly that are capable of avoiding skidding due to excessive braking and therefore can maintain control of the bicycle.

One embodiment of the disclosure provides a control method for an anti-lock brake device of a bicycle. The control method includes determining whether a wheel deceleration of the bicycle is larger than or equal to a deceleration threshold. When the wheel deceleration of the bicycle is determined to be smaller than the deceleration threshold, the anti-lock brake device of the bicycle is inactivated. When the wheel deceleration of the bicycle is determined to be larger than or equal to the deceleration threshold, determining whether a wheel speed of the bicycle is larger than or equal to a wheel speed threshold. When the wheel speed of the bicycle is determined to be larger than or equal to the wheel speed threshold, the anti-lock brake device of the bicycle is activated. when the wheel speed of the bicycle is determined to be smaller than the wheel speed threshold, the anti-lock brake device of the bicycle is inactivated.

Another embodiment of the disclosure provides a control method for an anti-lock brake device of a bicycle. The control method includes determining whether a wheel speed of the bicycle is larger than or equal to a wheel speed threshold. When the wheel speed of the bicycle is determined to be smaller than the wheel speed threshold, the anti-lock brake device of the bicycle is inactivated. When the wheel speed of the bicycle is determined to be larger than or equal to the wheel speed threshold, determining whether a wheel deceleration of the bicycle is larger than or equal to a deceleration threshold. When the wheel deceleration of the bicycle is determined to be larger than or equal to the deceleration threshold, the anti-lock brake device of the bicycle is activated. When the wheel deceleration of the bicycle is determined to be smaller than the deceleration threshold, the anti-lock brake device of the bicycle is inactivated.

Still another embodiment of the disclosure provides an anti-lock brake assembly for a bicycle. The anti-lock brake assembly includes a brake caliper, an anti-lock brake device, a control unit, and a switch. The anti-lock brake device is connected to the brake caliper. The anti-lock brake device includes an accommodation component, an oil pipe connector, a driving component, and a depressurizing component. The oil pipe connector is mounted on the accommodation component, and the driving component and the depressurizing component is located in the accommodation component. The control unit is electrically connected to the driving component. The switch is disposed on the oil pipe connector and electrically connected to the control unit. The control unit is configured to determine a braking state of the brake caliper via an activation of the switch, and the anti-lock brake device is configured to be controlled by the control unit to selectively depressurize the brake caliper.

Yet another embodiment of the disclosure provides an anti-lock brake assembly for a bicycle. The anti-lock brake assembly includes a brake caliper, an anti-lock brake device, a control unit, and a switch. The brake caliper includes a main body, two linings, and an elastic component. The main body has two pistons located opposite to each other. The two linings are located between the two pistons. The elastic component is located between the two linings. The elastic component has two arm portions located opposite to each other, and the two arm portions respectively press against the two linings. The anti-lock brake device is connected to the main body of the brake caliper. The control unit is electrically connected to the anti-lock brake device. The switch is fixed on one of the arm portions and located between the arm portions, wherein the switch is electrically connected to the control unit. The control unit is configured to determine a braking state of the brake caliper via an activation of the switch, and the anti-lock brake device is configured to be controlled by the control unit to selectively depressurize the brake caliper.

According to the control methods for the anti-lock brake device and the anti-lock brake assemblies for bicycle as discussed above, when the wheel deceleration of the bicycle is larger than or equal to the deceleration threshold, and the wheel speed of the bicycle is larger than or equal to the wheel speed threshold, the anti-lock brake device will be activated to depressurize the brake caliper to slightly loosen the brake disk, thereby preventing bicycle skidding due to excessively high-speed braking and therefore can effectively maintain control of the bicycle.

### BRIEF DESCRIPTION OF THE DRAWINGS

The present disclosure will become better understood from the detailed description given herein below and the accompanying drawings which are given by way of illustration only and thus are not intending to limit the present disclosure and wherein:

FIG. 1 is a perspective view of a bicycle anti-lock brake assembly according to a first embodiment of the disclosure;

FIG. 2 is a cross-sectional view of a brake caliper of the bicycle anti-lock brake assembly in FIG. 1;

FIG. 3 is an exploded view of an anti-lock brake device and a switch of the bicycle anti-lock brake assembly in FIG. 1;

FIG. 4 is another exploded view of the anti-lock brake device and the switch of the bicycle anti-lock brake assembly in FIG. 1;

FIG. 5 is a cross-sectional view of the anti-lock brake device and the switch in FIG. 1;

FIG. 6 is a partial enlarged cross-sectional view of the anti-lock brake device and the switch in FIG. 1;

FIG. 7 is a block diagram of a control unit, a circuit board, a first cable, and a second cable of the anti-lock brake device in FIG. 1;

FIG. 8 is a flow chart of a control method for the anti-lock brake device according to the first embodiment of the disclosure;

FIG. 9 is a partial enlarged cross-sectional view of the anti-lock brake device and the switch in FIG. 1 when the switch is activated;

FIG. 10 is a cross-sectional view of the anti-lock brake device in FIG. 1 when a depressurizing component is in a depressurizing position;

FIG. 11 is a flow chart of a control method for an anti-lock brake device according to a second embodiment of the disclosure; and

FIG. 12 is a cross-sectional view of a brake caliper according to a third embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In addition, the terms used in the present disclosure, such as technical and scientific terms, have its own meanings and can be comprehended by those skilled in the art, unless the terms are additionally defined in the present disclosure. That is, the terms used in the following paragraphs should be read on the meaning commonly used in the related fields and will not be overly explained, unless the terms have a specific meaning in the present disclosure.

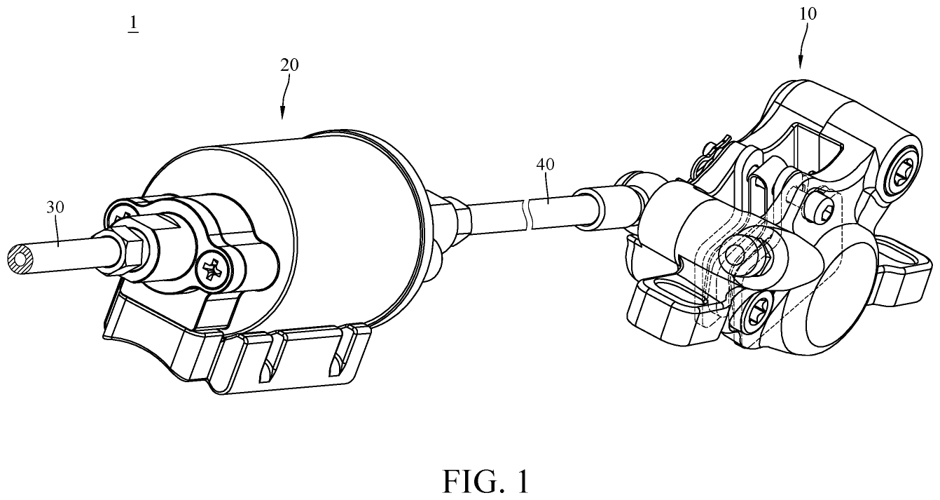

Referring to FIG. 1, there is shown a perspective view of a bicycle anti-lock brake assembly 1 according to a first embodiment of the disclosure.

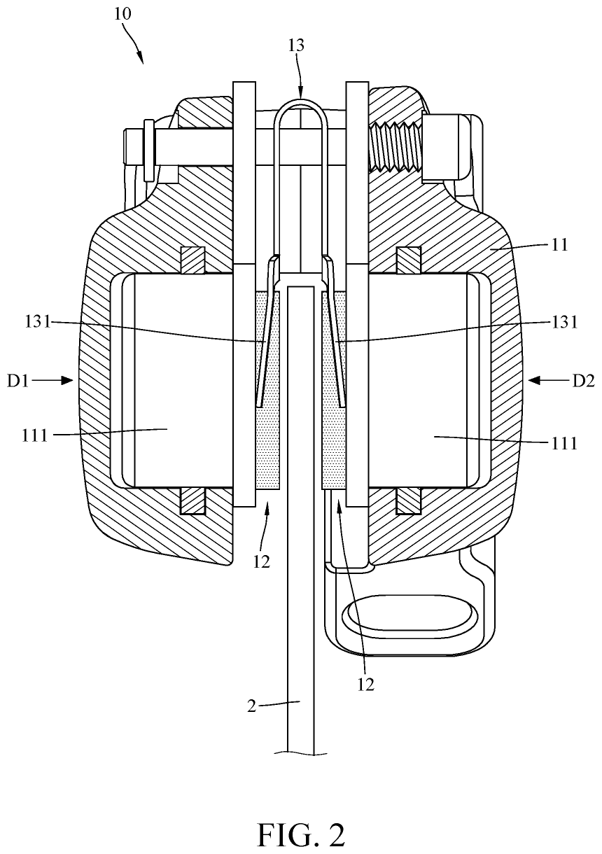

In this embodiment, the bicycle anti-lock brake assembly 1 includes a brake caliper 10 and an anti-lock brake device 20. The anti-lock brake device 20 is connected to a bicycle brake lever (not shown) via, for example, an oil pipe 30, and the anti-lock brake device 20 is connected to the brake caliper 10 via, for example, another oil pipe 40. The detailed descriptions of the brake caliper 10 and the anti-lock brake device 20 are provided hereinafter with further reference to FIG. 2.

FIG. 2 illustrates a cross-sectional view of the brake caliper 10 of the bicycle anti-lock brake assembly 1 in FIG. 1.

The brake caliper 10 includes a main body 11, two linings 12, and an elastic component 13. The oil pipe 40 is connected to the main body 11 of the brake caliper 10. The main body 11 has two pistons 111 located opposite to each other. The linings 12 are located between the pistons 111. The elastic component 13 is located between and clamped by the linings 12. The elastic component 13 has two arm portions 131 located opposite to each other and respectively pressing against the linings 12. When the brake lever is squeezed or engaged, oil pressure is produced and transmitted into the main body 11 of the brake caliper 10, the oil pipe 30, the anti-lock brake device 20, and the oil pipe 40 so as to force the pistons 111 to move the linings 12 towards each other to against a brake disk 2. As shown, during the movement of the pistons 111, the linings 12 are respectively forced to move along opposite directions D1 and D2.

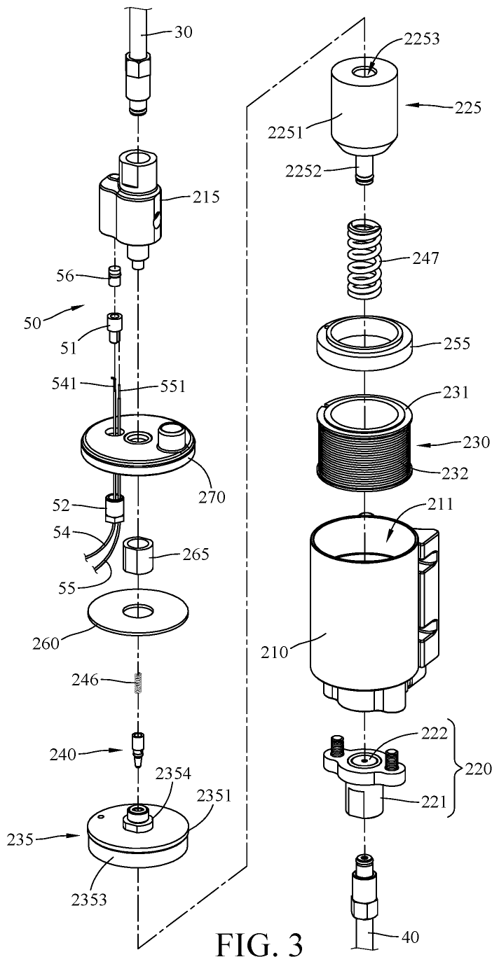

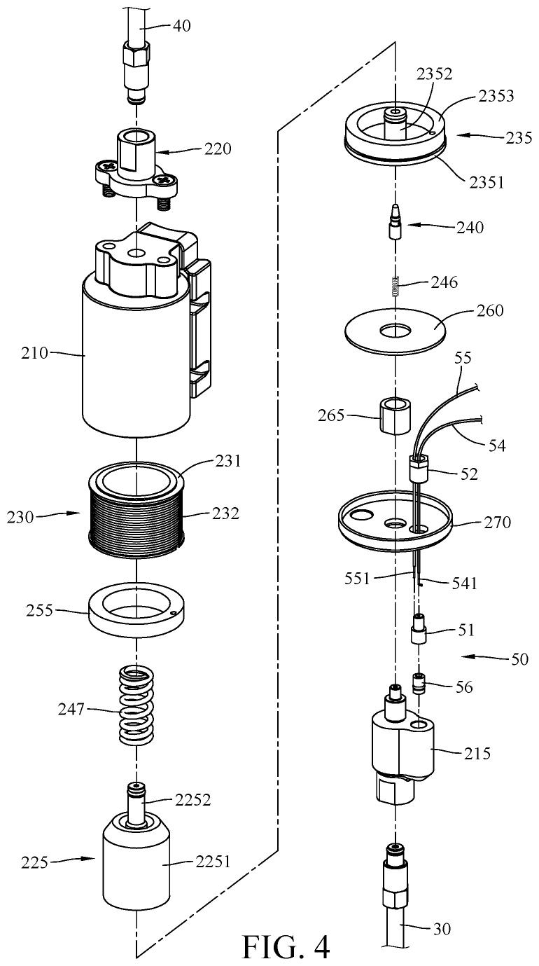

Then, referring to FIGS. 3 to 6, there are shown an exploded view of an anti-lock brake device and a switch of the bicycle anti-lock brake assembly in FIG. 1, another exploded view of the anti-lock brake device and the switch of the bicycle anti-lock brake assembly in FIG. 1, and a cross-sectional view of the anti-lock brake device and the switch in FIG. 1.

The anti-lock brake device 20 includes an accommodation component 210, two oil pipe connectors 215 and 220, a depressurizing component 225, and a driving component 230. In addition, in this embodiment or another embodiment, the anti-lock brake device 20 may further include a mount component 235, a valve 240, two elastic components 246 and 247, a coil cover 255, a circuit board 260, a ring-shaped fixing component 265, and a water-proof cover 270.

The accommodation component 210 has an accommodation space 211 therein. The accommodation space 211 has a first accommodation portion 2111 and a second accommodation portion 2112 connected to each other. The mount component 235 is located in the first accommodation portion 2111 of the accommodation space 211. The mount component 235 includes a plate portion 2351, a guide pillar portion 2352, an annular wall portion 2353, and a mount pillar portion 2354. The guide pillar portion 2352 and the annular wall portion 2353 are connected to the same surface of the plate portion 2351. The mount pillar portion 2354 is connected to another side of the plate portion 2351 opposite to the guide pillar portion 2352; that is, the mount pillar portion 2354 and the guide pillar portion 2352 protrude outwards from two opposite sides of the plate portion 2351. The oil pipe connector 215 is connected to the mount pillar portion 2354 and partially protrudes into a side of the first accommodation portion 2111 located away from the second accommodation portion 2112. The oil pipe 30 is connected to the oil pipe connector 215 so as to connect the brake lever to the oil pipe connector 215.

In this embodiment, the oil pipe connector 215 has a fluid channel 2151 therein, and the mount component 235 has a fluid channel 2355. The valve 240 is movably located in the fluid channel 2355 of the mount component 235. The valve 240 has a fluid channel 241 and two lateral openings 242 that are in fluid communication with each other. The fluid channel 2151 of the oil pipe connector 215 is in fluid communication with the fluid channel 2355 of the mount component 235 via the fluid channel 241 and the lateral openings 242 of the valve 240. The fluid channel 2151 of the oil pipe connector 215, the fluid channel 241 and the lateral openings 242 of the valve 240, and the fluid channel 2355 of the mount component 235 together form an oil inlet channel 275. The movement of the valve 240 can seal or open an oil inlet 280 of the oil inlet channel 275. Specifically, the fluid channel 2355 has a wide portion 2356 and a narrow portion 2357 connected to each other, and the wide portion 2356 has a width W1 larger than a width W2 of the narrow portion 2357. The oil inlet 280 of the oil inlet channel 275 is located at the narrow portion 2357 of the fluid channel 2355. The valve 240 includes a wide part 243, a narrow part 244, and a sealing ring 245. The wide part 243 of the valve 240 is connected to the narrow part 244, and the wide part 243 of the valve 240 has a width W3 larger than a maximum width W4 of the narrow part 244 of the valve 240. The sealing ring 245 of the valve 240 is sleeved on the narrow part 244 of the valve 240. The fluid channel 241 of the valve 240 extends from the wide part 243 to the narrow part 244, and the lateral openings 242 are located at the narrow part 244 of the valve 240. The sealing ring 245 is located closer to the oil inlet 280 of the oil inlet channel 275 than the lateral openings 242. The wide part 243 and the narrow part 244 of the valve 240 are respectively and movably located in the wide portion 2356 and the narrow portion 2357 of the fluid channel 2355. The movement of the valve 240 can move the sealing ring 234 to seal or open the oil inlet 280 of the oil inlet channel 275.

The elastic component 246 is located in the wide portion 2356 of the fluid channel 2355 of the mount component 235, and the elastic component 246 has two opposite ends respectively pressing against the oil pipe connector 215 and the wide part 243 of the valve 240. The elastic component 246 is configured to force the valve 240 to seal the oil inlet 280.

The oil pipe connector 220 includes a mount part 221 and a buffering part 222. The mount part 221 is mounted on the accommodation component 210 and located at a side of the second accommodation portion 2112 located away from the first accommodation portion 2111, and the buffering part 222 is located between and clamped by the mount part 221 and the accommodation component 210. The oil pipe 40 is connected to the mount part 221 of the oil pipe connector 220 so as to connect the brake caliper 10 to the mount part 221. The buffering part 222 has an oil outlet channel 2221. The oil outlet channel 2221 has two opposite ends that are respectively connected to and in fluid communication with the second accommodation portion 2112 and the oil pipe 40.

The depressurizing component 225 includes a wide pillar part 2251 and a narrow pillar part 2252. The wide pillar part 2251 is located in the first accommodation portion 2111 of the accommodation component 210. The wide pillar part 2251 has a guide recess 2253, two through holes 2254, an insertion hole 2255, and an accommodation recess 2256 connected to one another. The through holes 2254 and the insertion hole 2255 are located between the guide recess 2253 and the accommodation recess 2256, and the through holes 2254 are located closer to the guide recess 2253 than the insertion hole 2255. The guide pillar portion 2352 of the mount component 235 is inserted into the guide recess 2253 of the wide pillar part 2251. The narrow pillar part 2252 includes an insertion portion 2257 and an extension portion 2258 connected to each other. The insertion portion 2257 of the narrow pillar part 2252 is inserted into the insertion hole 2255 of the wide pillar part 2251, and different portions of the extension portion 2258 of the narrow pillar part 2252 are respectively located in the accommodation recess 2256 and the second accommodation portion 2112 of the accommodation component 210. In this embodiment, the narrow pillar part 2252 has a fluid channel 2259. The fluid channel 2259 penetrates through the insertion portion 2257 and the extension portion 2258. The two through holes 2254, the insertion hole 2255 of the wide pillar part 2251, and the fluid channel 2259 of the narrow pillar part 2252 together form a connection channel 285. The connection channel 285 has an end corresponding to the oil inlet channel 275 and another end that is in fluid communication with the oil outlet channel 2221 via the second accommodation portion 2112.

In this embodiment, there is a first chamber 290 located between and connected to the oil inlet channel 275 and the connection channel 285 in the guide recess 2253, and there is a second chamber 295 located between and connected to the oil outlet channel 2221 and the connection channel 285 in the second accommodation portion 2112. The first chamber 290 has a width substantially the same as a width W5 of the guide recess 2253 of the wide pillar part 2251, and the second chamber 295 has a width substantially the same as a width W6 of the second accommodation portion 2112. The width W5 of the first chamber 290 is larger than the width W6 of the second chamber 295.

The elastic component 247 is sleeved on the extension portion 2258 of the narrow pillar part 2252, and the elastic component 247 is partially located in the accommodation recess 2256 of the wide pillar part 2251. The elastic component 247 has two opposite ends that respectively press against the wide pillar part 2251 and the accommodation component 210. The elastic component 247 is configured to force the entire depressurizing component 225 to move towards the plate portion 2351 of the mount component 235.

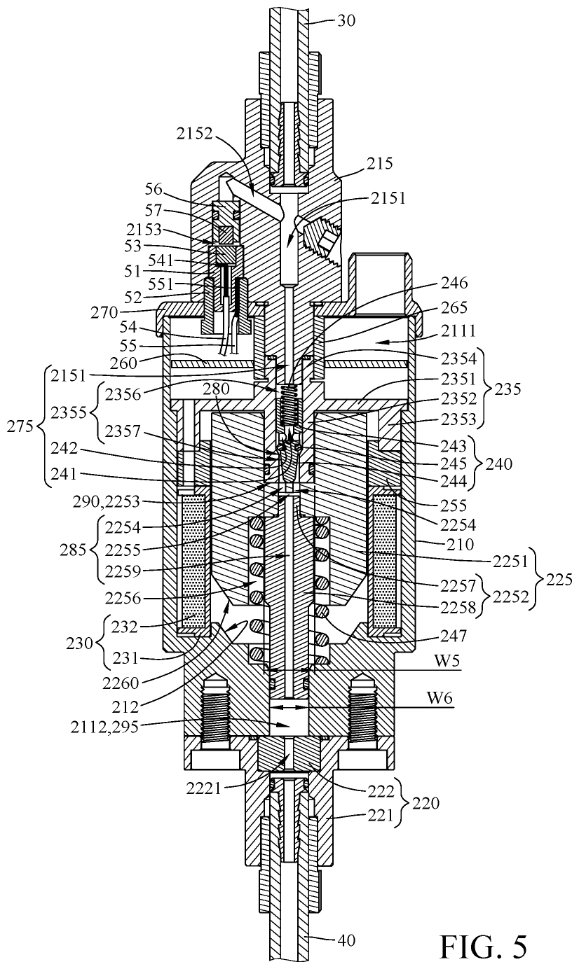

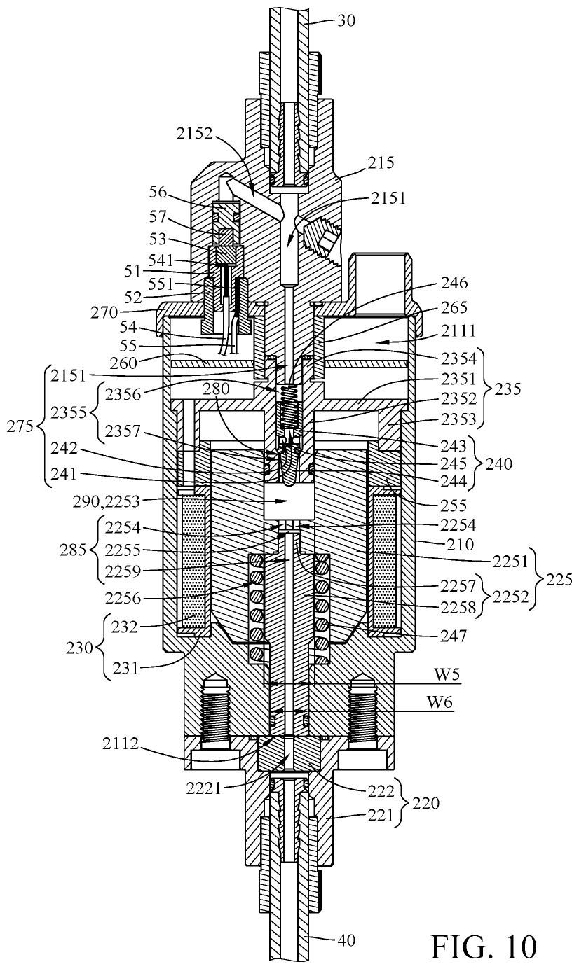

The driving component 230 includes a spool 231 and a coil 232. The spool 231 is located in the first accommodation portion 2111 of the accommodation component 210 and is sleeved on the wide pillar part 2251 of the depressurizing component 225. The coil 232 is wound on the spool 231. In this embodiment, the accommodation component 210 is, for example, made of a magnetically conductive material. When a current is applied on the coil 232, the coil 232 can apply a magnetic force to move the wide pillar part 2251 of the depressurizing component 225 towards a depressurizing position (as shown in FIG. 10 discussed in later paragraphs) from an initial position (as shown in FIG. 5). As shown in FIG. 5, when the depressurizing component 225 is in the initial position, the first chamber 290 is eliminated and therefore substantially has no volume, and the wide pillar part 2251 of the depressurizing component 225 presses against the narrow part 244 of the valve 240 to open the oil inlet 280 of the oil inlet channel 275, such that the oil inlet channel 275, the connection channel 285, and the oil outlet channel 2221 are in fluid communication with one another.

In this embodiment, the accommodation component 210 has a first inclined surface 212, and the wide pillar part 2251 of the depressurizing component 225 has a second inclined surface 2260. The first inclined surface 212 corresponds to the second inclined surface 2260. In this embodiment, the first inclined surface 212 of the accommodation component 210 and the second inclined surface 2260 of the wide pillar part 2251 of the depressurizing component 225 can help the transmission of the magnetic force between the coil 232 and the depressurizing component 225.

The coil cover 255 is located in the first accommodation portion 2111 of the accommodation component 210 and is sleeved on the wide pillar part 2251 of the depressurizing component 225. The coil cover 255 is located between and in contact with the annular wall portion 2353 of the mount component 235 and the spool 231 of the driving component 230.

The ring-shaped fixing component 265 is sleeved on the oil pipe connector 215 and the mount pillar portion 2354 of the mount component 235 so as to surround the part of the oil pipe connector 215 being inserted into the mount pillar portion 2354. The circuit board 260 is mounted on the ring-shaped fixing component 265. The circuit board 260 is electrically connected to the coil 232 of the driving component 230. The water-proof cover 270 is mounted on the accommodation component 210 and located at a side of the first accommodation portion 2111 located away from the second accommodation portion 2112, and located between and clamped by the ring-shaped fixing component 265 and the oil pipe connector 215.

In this embodiment, the bicycle anti-lock brake assembly 1 further includes a switch 50. The switch 50 is disposed in the oil pipe connector 215. The switch 50 can be activated by, for example, an oil pressure.

In detail, the oil pipe connector 215 further has a lateral channel 2152 and an accommodation space 2153 in fluid communication with the fluid channel 2151 of the oil pipe connector 215 via the lateral channel 2152. The switch 50 includes a wire arrangement component 51, a fastener 52, a first magnetic component 53, a first cable 54, a second cable 55, an electrically conductive piston 56, and a second magnetic component 57. The wire arrangement component 51 is located in the accommodation space 2153 of the oil pipe connector 215. The fastener 52 is disposed through the water-proof cover 270 and fixed with the oil pipe connector 215, and the fastener 52 has different parts respectively located in the first accommodation portion 2111 of the accommodation component 210 and the accommodation space 2153 of the oil pipe connector 215. The fastener 52 is sleeved on part of the wire arrangement component 51. The first magnetic component 53 and the first cable 54 is embedded in the wire arrangement component 51, and the second cable 55 is located between and clamped by the wire arrangement component 51 and the fastener 52. The electrically conductive piston 56 is located in the accommodation space 2153 of the oil pipe connector 215 and is located closer to an end of the lateral channel 2152 connected to the accommodation space 2153 than the wire arrangement component 51. The second magnetic component 57 is embedded in the electrically conductive piston 56. The second magnetic component 57 and the first magnetic component 53 are magnetically repulsive to each other.

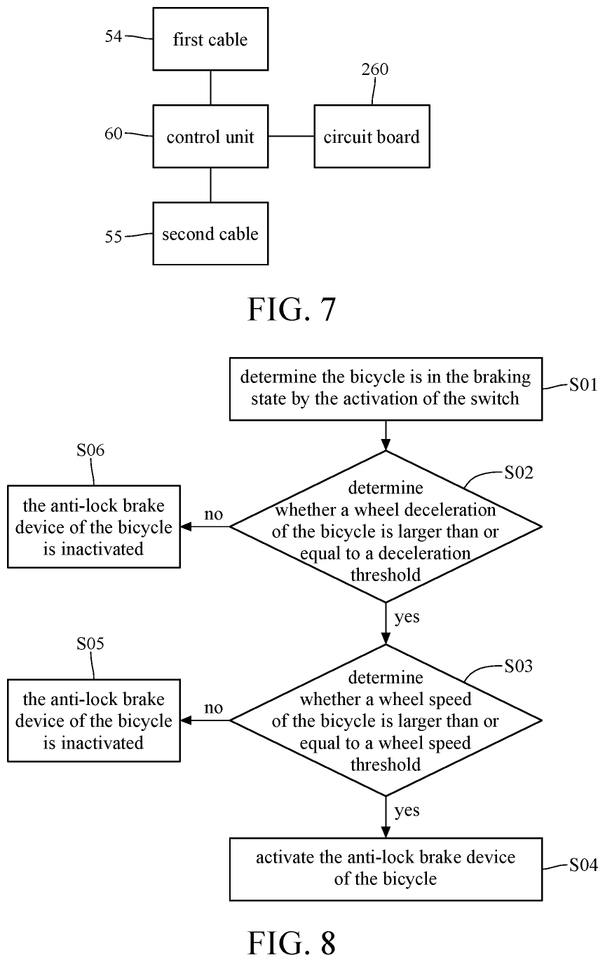

Then, referring to FIG. 7, there is shown a block diagram of a control unit 60, the circuit board 260, the first cable 54, and the second cable 55 of the anti-lock brake device 20 in FIG. 1. In this embodiment, the bicycle anti-lock brake assembly 1 further includes a control unit 60. The control unit 60 is, for example, located on a bicycle handlebar. The first cable 54, the second cable 55 and the circuit board 260 of the anti-lock brake device 20 are, for example, electrically connected to the control unit 60.

In this embodiment, the first cable 54 has a wire 541, the wire 541 is electrically in contact with the first magnetic component 53. In addition, the wire arrangement component 51 is made of an electrically insulation material. The fastener 52, the oil pipe connector 215, and the electrically conductive piston 56 are made of metal materials. The second cable 55 has a wire 551. The wire 551 of the second cable 55 is electrically connected to the second magnetic component 57 via the fastener 52, the oil pipe connector 215, and the electrically conductive piston 56.

In this embodiment, the electrically conductive piston 56 is movable between an initial position and a contact position. As shown in FIG. 5. when the brake lever is yet not squeezed, the oil pressure does not enough to overcome the repulsing force between the first magnetic component 53 and the second magnetic component 57 so that the electrically conductive piston 56 stays in the initial position. At this moment, the first magnetic component 53 is spaced apart from the second magnetic component 57, and the wire 541 of the first cable 54 is electrically insulated from the wire 551 of the second cable 55 via the wire arrangement component 51, such that the switch 50 is in an inactivated state. Thus, the control unit 60 determines that the brake lever is not squeezed yet.

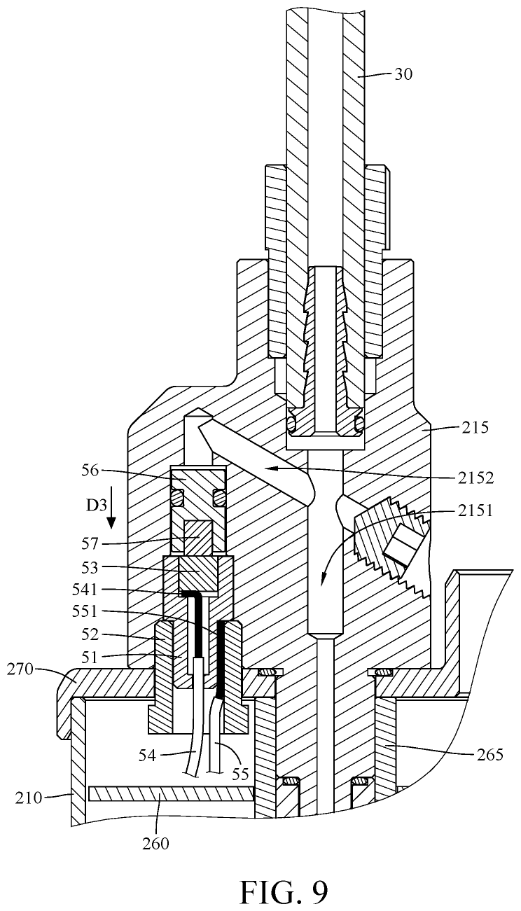

Then, the following will introduce a control method for the anti-lock brake device 20. Referring to FIGS. 8 and 9, there is shown a flow chart of the control method and a partial enlarged cross-sectional view of the anti-lock brake device 20 and the switch 50 in FIG. 1 when the switch is activated. In this embodiment, the method for controlling the anti-lock brake device 20 at least includes the following steps.

Firstly, a step S01 is to determine the bicycle is in the braking state by the activation of the switch 50. In detail, when the brake lever is squeezed, oil pressure is produced and transmitted into the oil pipe connector 215 of the anti-lock brake device 20 via the brake lever and the oil pipe 30, then the oil pressure is transmitted into the lateral channel 2152 from the fluid channel 2151 of the oil pipe connector 215 so as to force the electrically conductive piston 56 to move towards the contact position (e.g., along a direction D3) and thereby moving the first magnetic component 53 and the second magnetic component 57 towards each other and to contact each other. Meanwhile, as shown in FIG. 5, the oil entering into the oil pipe connector 215 will be also transmitted into the brake caliper 10 via the oil inlet channel 275, the connection channel 285, the oil outlet channel 2221, and the oil pipe 40 so as to brake the bicycle. When the electrically conductive piston 56 reaches the contact position, the first magnetic component 53 and the second magnetic component 57 are in electrical contact with each other, such that the wire 541 of the first cable 54 is electrically connected to the wire 551 of the second cable 55 via the first magnetic component 53, the second magnetic component 57, the electrically conductive piston 56, the oil pipe connector 215, and the fastener 52, thereby activating the switch 50. That is, when the electrically conductive piston 56 is in the contact position, the electrical path between the wire 541 of the first cable 54 and the wire 551 of the second cable 55 for activating the switch 50 includes the first magnetic component 53, the second magnetic component 57, the electrically conductive piston 56, the oil pipe connector 215, and the fastener 52. Once the wire 541 of the first cable 54 and the wire 551 of the second cable 55 are electrically connected (or, once the switch 50 is activated), the control unit 60 determines that the brake lever is squeezed.

Then, a step S02 is to determine whether a wheel deceleration of the bicycle is larger than or equal to a deceleration threshold. For example, there is a sensor (not shown) disposed on the wheel of the bicycle for obtaining the wheel deceleration, and this sensor is electrically connected to the control unit 60. When or after the control unit 60 determines that the brake lever is squeezed, the control unit 60 receives the wheel deceleration and based on which to determine whether the wheel deceleration of the wheel of the bicycle is larger than or equal to the deceleration threshold. In this embodiment, the deceleration threshold is, for example, 3.3 m/s².

When the control unit 60 determines that the wheel deceleration of the bicycle is larger than or equal to the deceleration threshold, a step S03 is performed. The step S03 is to determine whether a wheel speed of the bicycle is larger than or equal to a wheel speed threshold; that is, after the control unit 60 determines that the wheel deceleration of the wheel of the bicycle is larger than or equal to the deceleration threshold, the control unit 60 will further determine whether the wheel speed of the wheel of the bicycle is larger than or equal to the wheel speed threshold. In this embodiment, the wheel speed threshold is, for example, 10 km/hr.

When the control unit 60 determines that the wheel speed of the bicycle is larger than or equal to the wheel speed threshold, a step S04 is performed. The step S04 is to activate the anti-lock brake device 20 of the bicycle. In detail, referring FIG. 10, there is shown a cross-sectional view of the anti-lock brake device 20 in FIG. 1 when the depressurizing component 225 is in a depressurizing position. When or after the control unit 60 determines that the wheel speed of the wheel of the bicycle is larger than or equal to the wheel speed threshold, the control unit 60 commands an electric current to flow through the coil 232 from the circuit board 260 in order to move the depressurizing component 225 towards the depressurizing position. During the movement of the depressurizing component 225, the wide pillar part 2251 of the depressurizing component 225 is moved away from the narrow part 244 of the valve 240, such that the elastic component 246 is released to move the sealing ring 245 of the valve 240 to seal the oil inlet 280, thereby disconnecting the oil inlet channel 275 from the connection channel 285 and the oil outlet channel 2221. As shown in FIG. 9, when the depressurizing component 225 reaches the depressurizing position, the volume of the first chamber 290 is increased and the volume of the second chamber 295 is decreased or eliminated. Since the first chamber 290 has the width W5 larger than the width W6 of the second chamber 295, the volume increase of the first chamber 290 is larger than the volume decrease of the second chamber 295, such that there is an additional room for the first chamber 290 to accommodate oil, thereby depressurizing the brake caliper 10.

It is noted that bicycle skidding often occurs when the wheel deceleration is too large (e.g., larger than or equal to the deceleration threshold) and the wheel speed is too high (e.g., higher than the wheel speed threshold). To avoid that, the activation of the anti-lock brake device 20 can depressurize the brake caliper 10 so as to slightly loosen the brake disk 2, thereby preventing bicycle skidding due to excessively high-speed braking and therefore can effectively maintain control of the bicycle.

Then, the control unit 60 stops the electric current from feeding into the coil 232 and thus removing the magnetic force applied on the depressurizing component 225. At this moment, the elastic component 247 forces the depressurizing component 225 to move back to the initial position, such that the wide pillar part 2251 presses against the narrow part 244 of the valve 240 so as to move the sealing ring 245 away from the oil inlet 280, and thus connecting the oil inlet channel 275 with the oil outlet channel 2221. Therefore, the oil pressure can be transmitted to the brake caliper 10 again for braking the bicycle.

In the step S03, when the wheel speed of the bicycle is smaller than the wheel speed threshold, a step S05 is performed. In the step S05, the anti-lock brake device 20 of the bicycle is inactivated; that is, although the wheel deceleration of the bicycle is larger than or equal to the deceleration threshold, the bicycle is determined not likely to skid and therefore has no need to activate the anti-lock brake device 20.

In the step S02, when the wheel deceleration of the bicycle is smaller than the deceleration threshold, a step S06 is performed. In the step S06, the anti-lock brake device 20 of the bicycle is inactivated; that is, the possibility of the skidding of wheel is still low as the low wheel deceleration. Therefore, there is no need for activating the anti-lock brake device 20.

In this embodiment, the above steps are repeatedly performed until the brake lever is fully released.

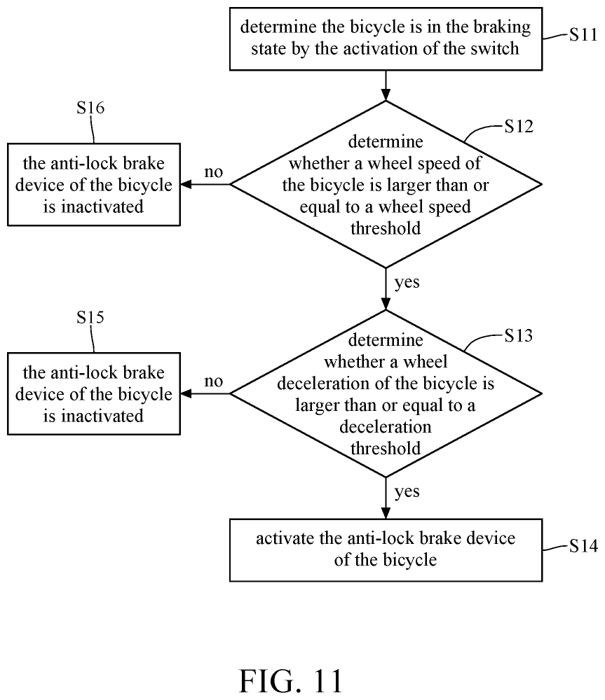

Note that the order of the steps of the control method is not intended to limit the disclosure. Referring to FIG. 11, there is a flow chart of a control method for an anti-lock brake device 20 according to a second embodiment of the disclosure. In this embodiment, the method for controlling the anti-lock brake device 20 at least includes the following steps.

Firstly, a step S11 is performed. The step S11 is to determine the bicycle is in the braking state by the activation of the switch 50. Then, a step S12 is performed. The step S12 is to determine whether a wheel speed of the bicycle is larger than or equal to a wheel speed threshold. When the wheel speed of the bicycle is determined to be larger than or equal to the wheel speed threshold, a step S13 is performed. The step S13 is to determine whether a wheel deceleration of the bicycle is larger than or equal to a deceleration threshold. When the wheel deceleration of the bicycle is determined to be larger than or equal to the deceleration threshold, a step S14 is performed. The step S14 is to activate the anti-lock brake device 20 of the bicycle. In the step S13, when the wheel deceleration of the bicycle is determined to be smaller than deceleration threshold, a step S15 is performed. In the step S15, the anti-lock brake device 20 of the bicycle is inactivated. In the step S12, when the wheel speed of the bicycle is determined to be smaller than the wheel speed threshold, a step S16 is performed. In the step S16, the anti-lock brake device 20 of the bicycle is inactivated.

In the previous embodiments, the aforementioned control methods are cooperated with the anti-lock brake device 20, but the disclosure is not limited thereto; in some other embodiment, the control method may be cooperated with an anti-lock brake device of another type.

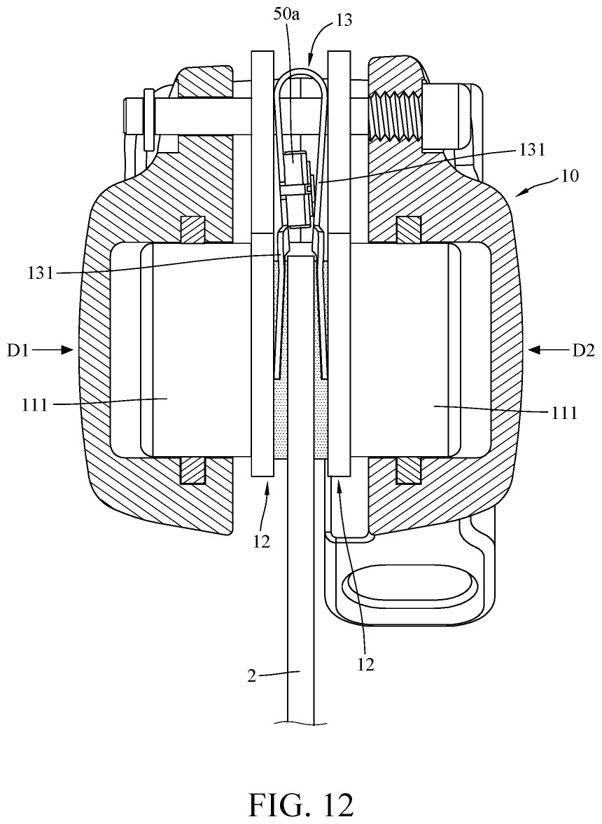

Note that the type and the position of the switch is not intended to limit the disclosure. For example, referring to FIG. 12, there is shown a cross-sectional view of a brake caliper according to a third embodiment of the disclosure.

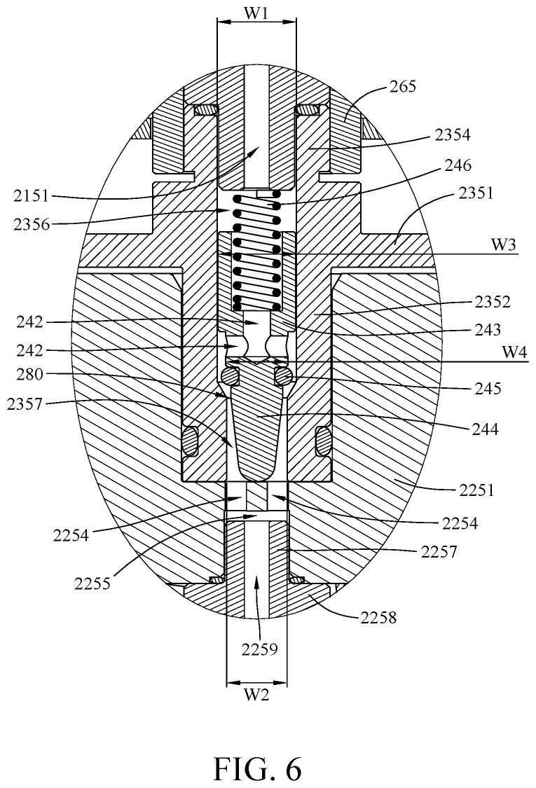

In this embodiment, the switch 50a is, for example, a pressing-typed switch; that is, the switch 50a can be activated by pressing. The switch 50a is fixed on one of the arm portions 131 of the elastic component 13 of the brake caliper 10 and located between the arm portions 131. The switch 50a is electrically connected to the control unit 60 (as shown in FIG. 6). When the brake lever is squeezed, the pistons 111 move the linings 12 towards each other to against the brake disk 2 (e.g., along the directions D1 and D2). During the movements of the linings 12, the linings 12 respectively force the arm portions 131 move towards each other, such that the arm portion 131 presses and activates the switch 50a. Accordingly, the control unit 60 can determine the brake lever has been squeezed by the activation of the switch 50.

According to the control methods for the anti-lock brake device and the anti-lock brake assemblies for bicycle as discussed above, when the wheel deceleration of the bicycle is larger than or equal to the deceleration threshold, and the wheel speed of the bicycle is larger than or equal to the wheel speed threshold, the anti-lock brake device will be activated to depressurize the brake caliper to slightly loosen the brake disk, thereby preventing bicycle skidding due to excessively high-speed braking and therefore can effectively maintain control of the bicycle.

It will be apparent to those skilled in the art that various modifications and variations can be made to the present disclosure. It is intended that the specification and examples be considered as exemplary embodiments only, with a scope of the disclosure being indicated by the following claims and their equivalents.

What is claimed is:

1. A control method for an anti-lock brake device of a bicycle, comprising:
determining whether a wheel deceleration of the bicycle is larger than or equal to a deceleration threshold;
when the wheel deceleration of the bicycle is determined to be smaller than the deceleration threshold, the anti-lock brake device of the bicycle is inactivated;
when the wheel deceleration of the bicycle is determined to be larger than or equal to the deceleration threshold, determining whether a wheel speed of the bicycle is larger than or equal to a wheel speed threshold;
when the wheel speed of the bicycle is determined to be larger than or equal to the wheel speed threshold, the anti-lock brake device of the bicycle is activated; and
when the wheel speed of the bicycle is determined to be smaller than the wheel speed threshold, the anti-lock brake device of the bicycle is inactivated.

2. The control method according to claim 1, wherein before determining whether the wheel deceleration of the bicycle is larger than or equal to the deceleration threshold, the control method further comprises:
determining the bicycle is in a braking state by an activation of a switch, wherein the switch is disposed on the anti-lock brake device or a brake caliper of the bicycle.

3. A control method for an anti-lock brake device of a bicycle, comprising:
determining whether a wheel speed of the bicycle is larger than or equal to a wheel speed threshold;
when the wheel speed of the bicycle is determined to be smaller than the wheel speed threshold, the anti-lock brake device of the bicycle is inactivated;
when the wheel speed of the bicycle is determined to be larger than or equal to the wheel speed threshold, determining whether a wheel deceleration of the bicycle is larger than or equal to a deceleration threshold;
when the wheel deceleration of the bicycle is determined to be larger than or equal to the deceleration threshold, the anti-lock brake device of the bicycle is activated; and
when the wheel deceleration of the bicycle is determined to be smaller than the deceleration threshold, the anti-lock brake device of the bicycle is inactivated.

4. The control method according to claim 3, wherein before determining whether the wheel speed of the bicycle is larger than or equal to the wheel speed threshold, further comprising:
determining the bicycle is in a braking state by an activation of a switch, wherein the switch is disposed on the anti-lock brake device or a brake caliper of the bicycle.

5. An anti-lock brake assembly for a bicycle, comprising:
a brake caliper;
an anti-lock brake device, connected to the brake caliper, wherein the anti-lock brake device comprises an accommodation component, an oil pipe connector, a driving component, and a depressurizing component, the oil pipe connector is mounted on the accommodation component, and the driving component and the depressurizing component is located in the accommodation component;
a control unit, electrically connected to the driving component; and
a switch, disposed on the oil pipe connector and electrically connected to the control unit;
wherein the control unit is configured to determine a braking state of the brake caliper via an activation of the switch, and the anti-lock brake device is configured to be controlled by the control unit to selectively depressurize the brake caliper.

6. An anti-lock brake assembly for a bicycle, comprising:
a brake caliper, comprising a main body, two linings, and an elastic component, wherein the main body has two pistons located opposite to each other, the two linings are located between the two pistons, the elastic component is located between the two linings, the elastic component has two arm portions located opposite to each other, and the two arm portions respectively press against the two linings;
an anti-lock brake device, connected to the main body of the brake caliper;
a control unit, electrically connected to the anti-lock brake device; and
a switch, fixed on one of the arm portions and located between the arm portions, wherein the switch is electrically connected to the control unit;
wherein the control unit is configured to determine a braking state of the brake caliper via an activation of the switch, and the anti-lock brake device is configured to be controlled by the control unit to selectively depressurize the brake caliper.
